(19) United States
(12) Patent Application Publication
(10) Pub. No.: US 2021/0039681 A1
(43) Pub. Date: Feb. 11, 2021

(54) VEHICLE DRIVING SYSTEM

(71) Applicant: TOYOTA JIDOSHA KABUSHIKI KAISHA, Toyota-shi (JP)

(72) Inventors: Kohta TARAO, Nagoya-shi (JP); Hiroki AWANO, Tokyo-to (JP); Kuniaki JINNAI, Nagoya-shi (JP); Yoshihiro MAEKAWA, Toyota-shi (JP)

(73) Assignee: TOYOTA JIDOSHA KABUSHIKI KAISHA, Toyota-shi (JP)

(21) Appl. No.: 16/986,457

(22) Filed: Aug. 6, 2020

(30) Foreign Application Priority Data
Aug. 9, 2019 (JP) 2019-147196

(51) Int. Cl. B60W 60/00; B60W 40/08; G05D 1/00; B60W 50/14; G08G 1/00; A61G 3/00

(52) U.S. Cl. CPC B60W 60/0059; B60W 40/08; G05D 1/0011; A61G 2203/10; G08G 1/22; A61G 3/001; B60W 2540/221; B60W 50/14

(57) ABSTRACT

A vehicle driving system includes: an acquisition unit that acquires information relating to a state of a driver driving a first vehicle in a manual driving mode; a switching control unit that switches the first vehicle from the manual driving mode to a remote driving mode in a case in which it is verified, by means of the information acquired by the acquisition unit, that it is difficult for the driver to drive; and a notification unit that, in a case in which the first vehicle is switched to the remote driving mode by the switching control unit, notifies a second vehicle located within a predetermined range from the first vehicle that the first vehicle has become an urgent vehicle.

### CROSS-REFERENCE TO RELATED APPLICATION

This application is based upon and claims the benefit of priority of the prior Japanese Patent Application No. 2019-147196, filed on Aug. 9, 2019, the entire contents of which are incorporated herein by reference.

### BACKGROUND

### Technical Field

The embodiments discussed herein are related to a vehicle driving system.

### Related Art

Japanese Patent Application Laid-open (JP-A) No. 2017-182249 discloses a driving assistance system which, when switching from a self-driving mode (namely, an autonomous driving mode) to a manual driving mode, monitors the wakefulness of the driver and switches to the manual driving mode in a case where the driver is in a wakeful state.

However, the driving assistance system described in JP-A No. 2017-182249 only supposes monitoring the wakefulness of the driver when switching from the self-driving mode to the manual driving mode. For this reason, the driving assistance system cannot respond when the driver driving in the manual driving mode has fallen into a condition in which it is difficult to drive, and so the driving assistance system has room for improvement.

### SUMMARY

The present disclosure has been devised in view of the above point, and it is an object thereof to provide a vehicle driving system that, when the driver of a vehicle being driven in a manual driving mode has fallen into a condition in which it is difficult to drive, can smoothly drive the vehicle.

A vehicle driving system pertaining to a first aspect of the disclosure includes: an acquisition unit that acquires information relating to a state of a driver driving a first vehicle in a manual driving mode; a switching control unit that switches the first vehicle from the manual driving mode to a remote driving mode in a case in which it is verified, by means of the information acquired by the acquisition unit, that it is difficult for the driver to drive; and a notification unit that, in a case in which the first vehicle is switched to the remote driving mode by the switching control unit, notifies a second vehicle located within a predetermined range from the first vehicle that the first vehicle has become an urgent vehicle.

In the vehicle driving system pertaining to the first aspect, the acquisition unit acquires the information relating to the state of the driver driving the first vehicle in the manual driving mode. The switching control unit switches the first vehicle from the manual driving mode to the remote driving mode in a case in which it is verified, by means of the information relating to the state of the driver acquired by the acquisition unit, that it is difficult for the driver to drive. When the first vehicle is switched to the remote driving mode by the switching control unit, the notification unit notifies the second vehicle located within the predetermined range from the first vehicle that the first vehicle has become an urgent vehicle. Because of this, when it is difficult for the driver driving the first vehicle in the manual driving mode to drive, it becomes possible to move the second vehicle out of the way of the first vehicle by notifying the second vehicle that the first vehicle has become an urgent vehicle. For this reason, the first vehicle can be driven smoothly.

A vehicle driving system pertaining to a second aspect is the vehicle driving system of the first aspect, further including a detection unit that detects, by means of the information acquired by the acquisition unit, that the driver is in a condition in which it is difficult to drive.

In the vehicle driving system pertaining to the second aspect, the detection unit detects, by means of the information relating to the state of the driver acquired by the acquisition unit, that the driver is in a condition in which it is difficult to drive. For this reason, it can be detected at an early stage that the driver of the first vehicle has fallen into a condition in which it is difficult to drive.

A vehicle driving system pertaining to a third aspect is the vehicle driving system of the first aspect, wherein notification by the notification unit from the first vehicle to the second vehicle is performed via communication between the first vehicle and the second vehicle.

In the vehicle driving system pertaining to the third aspect, the notification given by the notification unit from the first vehicle to the second vehicle is performed via communication between the first vehicle and the second vehicle, so there is no need to provide an outside facility for the notification outside the first vehicle and the second vehicle.

A vehicle driving system pertaining to a fourth aspect is the vehicle driving system of the first aspect, wherein the notification unit notifies the second vehicle that the second vehicle needs to move out of a driving direction of the first vehicle.

In the vehicle driving system pertaining to the fourth aspect, the notification unit notifies the second vehicle that the second vehicle needs to move out of the driving direction of the first vehicle, so when the second vehicle moves out of the way of the first vehicle in response to the notification, the first vehicle can be driven smoothly.

A vehicle driving system pertaining to a fifth aspect is the vehicle driving system of the first aspect, further including another switching control unit that switches the second vehicle to a remote driving mode in a case in which the second vehicle has been notified by the notification unit that the first vehicle has become an urgent vehicle.

In the vehicle driving system pertaining to the fifth aspect, when the second vehicle has been notified by the notification unit that the first vehicle has become an urgent vehicle, the other switching control unit switches the second vehicle to the remote driving mode. Because of this, by using the remote driving mode to move the second vehicle out of the way of the first vehicle, the first vehicle can be driven smoothly.

A vehicle driving system pertaining to a sixth aspect is the vehicle driving system of the first aspect, wherein the acquisition unit is installed in the first vehicle or is portably carried by the driver of the first vehicle.

In the vehicle driving system pertaining to the sixth aspect, the acquisition unit is installed in the first vehicle or is portably carried by the driver of the first vehicle, so the information relating to the state of the driver driving the first vehicle can be acquired at an early stage by the acquisition unit.

A vehicle driving system pertaining to a seventh aspect is the vehicle driving system of the sixth aspect, wherein the acquisition unit is a vitals sensor that detects vital signs of the driver of the first vehicle.

In the vehicle driving system pertaining to the seventh aspect, the acquisition unit is a vitals sensor that detects the vital signs of the driver of the first vehicle, so it can be verified at an early stage, by means of the vital signs of the driver detected by the vitals sensor, that the driver of the first vehicle is in a condition in which it is difficult to drive.

A vehicle driving system pertaining to an eighth aspect is the vehicle driving system of the seventh aspect, further including a hospital information acquisition unit that acquires, in accordance with the vital signs detected by the vitals sensor, information associated with hospitals, within a predetermined range from the first vehicle, which are capable of admitting the driver.

In the vehicle driving system pertaining to the eighth aspect, the hospital information acquisition unit acquires, in accordance with the vital signs of the driver detected by the vitals sensor, the information associated with hospitals, within a predetermined range from the first vehicle, which are capable of admitting the driver. Because of this, time and effort spent searching for a hospital is alleviated compared to the case of individually searching for hospitals capable of admitting the driver of the first vehicle.

A vehicle driving system pertaining to a ninth aspect is the vehicle driving system of the eighth aspect, further including a destination setting unit that sets, in accordance with the information about the hospitals acquired by the hospital information acquisition unit, a destination of the first vehicle to an admitting hospital capable of admitting the driver.

In the vehicle driving system pertaining to the ninth aspect, the destination setting unit sets, in accordance with the information about the hospitals capable of admitting the driver acquired by the hospital information acquisition unit, the destination of the first vehicle to the admitting hospital capable of admitting the driver. For this reason, the driver can be transported at an early stage to the admitting hospital.

A vehicle driving system pertaining to a tenth aspect is the vehicle driving system of the ninth aspect, further including a vital signs transmission unit that transmits the vital signs of the driver to the admitting hospital.

In the vehicle driving system pertaining to the tenth aspect, the vital signs transmission unit that transmits the vital signs of the driver to the admitting hospital is provided, so the vital signs of the driver can be transmitted to the admitting hospital before the first vehicle reaches the admitting hospital.

A vehicle driving system pertaining to an eleventh aspect is the vehicle driving system of the first aspect, wherein the acquisition unit acquires, by means of a drive recorder provided in the second vehicle travelling in front of or behind the first vehicle, the information relating to the state of the driver of the first vehicle.

In the vehicle driving system pertaining to the eleventh aspect, the acquisition unit acquires, by means of the drive recorder provided in the second vehicle travelling in front of or behind the first vehicle, the information relating to the state of the driver of the first vehicle. For this reason, the information relating to the state of the driver of the first vehicle can be acquired by utilizing the drive recorder provided in the second vehicle, and it is possible to lower costs compared to the case of providing a new acquisition unit outside the first vehicle.

A vehicle driving system pertaining to a twelfth aspect includes at least one processor. The processor is configured to acquire information relating to a state of a driver driving a first vehicle in a manual driving mode; switch the first vehicle from the manual driving mode to a remote driving mode in a case in which it is verified, by means of the information, that it is difficult for the driver to drive; and notify a second vehicle located within a predetermined range from the first vehicle that the first vehicle has become an urgent vehicle.

A vehicle driving program pertaining to a thirteenth aspect causes a computer to execute processing, the processing including a step of acquiring information relating to a state of a driver driving a first vehicle in a manual driving mode; a step of switching the first vehicle from the manual driving mode to a remote driving mode in a case in which it is verified, by means of the information, that it is difficult for the driver to drive; and a step of notifying a second vehicle located within a predetermined range from the first vehicle that the first vehicle has become an urgent vehicle.

A vehicle driving method pertaining to a fourteenth aspect includes: an acquisition step of acquiring information relating to a state of a driver driving a first vehicle in a manual driving mode; a switching step of switching the first vehicle from the manual driving mode to a remote driving mode in a case in which it is verified, by means of the information acquired by the acquisition step, that it is difficult for the driver to drive; and a notification step of notifying, when the first vehicle is switched to the remote driving mode by the switching step, a second vehicle located within a predetermined range from the first vehicle that the first vehicle has become an urgent vehicle.

According to the vehicle driving system pertaining to the disclosure, when the driver of a vehicle being driven in a manual driving mode has fallen into a condition in which it is difficult to drive, the vehicle can be smoothly driven.

### BRIEF DESCRIPTION OF THE DRAWINGS

FIG. 1 is a drawing showing the schematic configuration of a vehicle driving system pertaining to a first embodiment;

FIG. 2 is a block diagram showing the hardware configuration of devices installed in vehicles;

FIG. 3 is a block diagram showing an example of the functional configuration of the vehicles;

FIG. 4 is a block diagram showing the hardware configuration of a remote operation device;

FIG. 5 is a block diagram showing an example of the functional configuration of the remote operation device;

FIG. 6 is a flowchart showing the flow of a first driving process performed by a vehicle control device of a first vehicle;

FIG. 7 is a flowchart showing the flow of a first driving process performed by the remote operation device;

FIG. 8 is a flowchart showing the flow of a second driving process performed by the vehicle control device of the first vehicle;

FIG. 9 is a drawing showing, in a bird's-eye view, plural vehicles driving on a road;

FIG. 10 is a flowchart showing the flow of a second driving process performed by the remote operation device;

FIG. 11 is a flowchart showing the flow of a third driving process performed by a vehicle control device of a second vehicle;

FIG. 12 is a drawing showing the schematic configuration of a vehicle driving system pertaining to a second embodiment;

FIG. 13 is a block diagram showing the hardware configuration of devices installed in a server device;

FIG. 14 is a block diagram showing an example of the functional configuration of the server device; and

FIG. 15 is a flowchart showing the flow of a driving process performed by the server device.

### DESCRIPTION OF EMBODIMENTS

Examples of embodiments of the disclosure will be described below with reference to the drawings. It will be noted that identical or equivalent constituent elements and parts in the drawings are assigned identical reference signs.

### First Embodiment

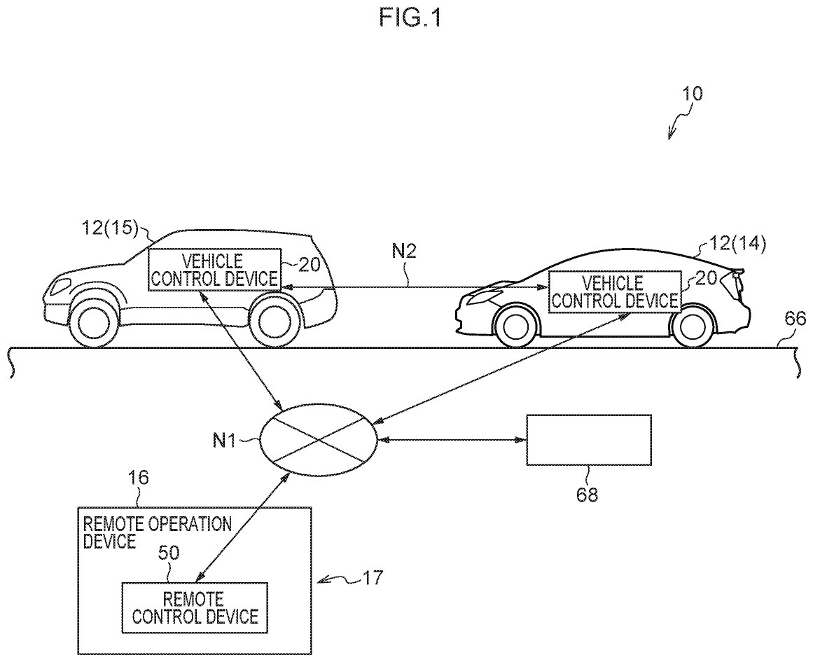

FIG. 1 is a drawing showing the schematic configuration of a vehicle driving system 10 pertaining to a first embodiment.

As shown in FIG. 1, the vehicle driving system 10 is configured to include plural vehicles 12 and a remote operation device 16 that is provided in a remote center 17. The plural vehicles 12 include a first vehicle 14 and a second vehicle 15 that is driving in the vicinity of the first vehicle 14. In the first embodiment, the first vehicle 14 is driven in a manual driving mode by a driver. The first vehicle 14 is configured to be set as an urgent vehicle and switched to a remote driving mode in accordance with information relating to the state of the driver described later.

The first embodiment describes as an example a case where, as shown in FIG. 1, the plural vehicles 12 are driving on a road 66 in which the direction of travel is the same. FIG. 1 shows the vehicles 12 sorted by reference signs into the first vehicle 14 and the second vehicle 15, but in cases where no distinction is made between the first vehicle 14 and the second vehicle 15, they will be described as “the vehicles 12.”

The first vehicle 14 and the second vehicle 15 each have a vehicle control device 20. The remote operation device 16 has a remote control device 50. In the vehicle driving system 10, the vehicle control device 20 of the first vehicle 14, the vehicle control device 20 of the second vehicle 15, and the remote control device 50 of the remote operation device 16 are connected to each other via a network N1. Furthermore, the vehicle control devices 20 are configured to be capable of directly communicating with each other by vehicle-to-vehicle communication N2. Furthermore, in the vehicle driving system 10, plural hospitals 68 capable of admitting the driver of the first vehicle 14 in a case where it has been verified, by means of information relating to the state of the driver of the first vehicle 14, that it is difficult for the driver to drive are connected via the network N1. It will be noted that FIG. 1 shows only one hospital 68 to facilitate understanding of the configuration of the vehicle driving system 10, but in reality plural hospitals 68 are connected.

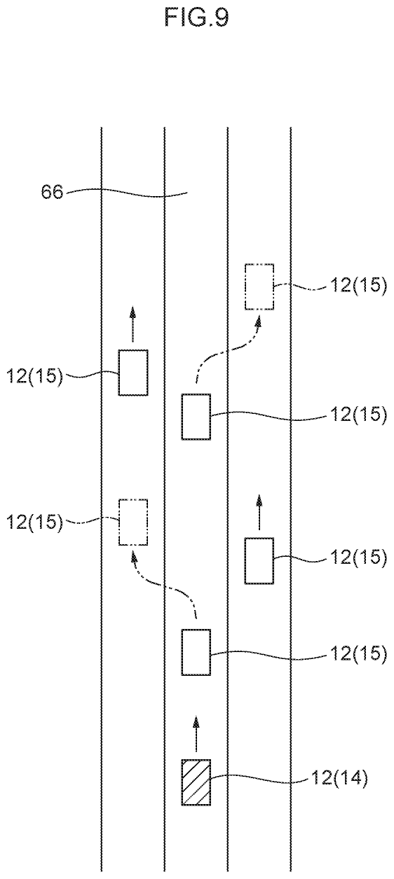

In FIG. 1, out of the plural vehicles 12, only the first vehicle 14 and the second vehicle 15 that is driving in front of the first vehicle 14 are shown, but in reality there are plural second vehicles 15 driving in the vicinity of the first vehicle 14 (see FIG. 9). It will be noted that although the vehicle driving system 10 shown in FIG. 1 is configured to include one remote operation device 16, it may also include more than one remote operation device 16.

The vehicles 12 are each configured to be capable of executing a self-driving mode (namely, an autonomous driving mode) in which the vehicle 12 drives autonomously on the basis of a driving plan generated by the vehicle control device 20, a remote driving mode based on operation of the remote operation device 16 by a remote driver, and a manual driving mode based on operation by a driver of the vehicle 12.

(Vehicles)

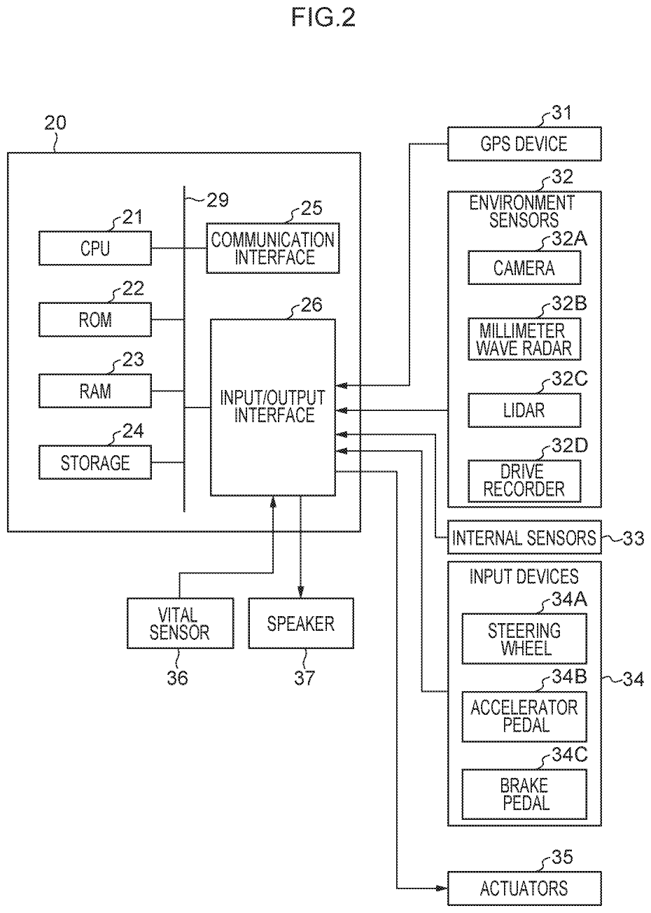

FIG. 2 is a block diagram showing the hardware configuration of devices installed in the vehicles 12. It will be noted that the vehicles 12 of the first embodiment have the same configuration in terms of the first vehicle 14 and the second vehicle 15. As shown in FIG. 2, each of the vehicles 12 has, in addition to the vehicle control device 20, a Global Positioning System (GPS) device 31, environment sensors (i.e., external sensors) 32, internal sensors 33, input devices 34, actuators 35, a vital sensor (i.e., vitals sensor) 36, and a speaker 37.

The vehicle control device 20 has a central processing unit (CPU; processor) 21, a read-only memory (ROM) 22, a random-access memory (RAM) 23, a storage 24, a communication interface (I/F) 25, and an input/output interface (I/F) 26. The CPU 21, the ROM 22, the RAM 23, the storage 24, the communication interface 25, and the input/output interface 26 are communicably connected to each other via a bus 29.

The CPU 21 executes various types of programs and controls each part. The CPU 21 reads the programs from the ROM 22 or the storage 24 and executes the programs using the RAM 23 as a work area. The CPU 21 controls each of the above configurations and performs various types of processing in accordance with the programs recorded in the ROM 22 or the storage 24. In the first embodiment, a vehicle driving program is stored in the ROM 22 or the storage 24.

The ROM 22 stores various types of programs and various types of data. The RAM 23 temporarily stores the programs or data as a work area.

The storage 24 is configured by a hard disk drive (HDD) or a solid-state drive (SSD) and stores various types of programs, including an operating system, and various types of data.

The communication interface 25 includes an interface for connecting to the network N1 in order to communicate with the other vehicle control devices 20, the remote control device 50, and communication devices (not shown in the drawings) of the hospitals 68. The interface uses a communication standard such as LTE or Wi-Fi (Wi-Fi is a registered trademark in Japan), for example. Furthermore, the communication interface 25 includes a wireless device for directly communicating with the other vehicle control devices 20 by the vehicle-to-vehicle communication N2 utilizing dedicated short-range communications (DSRC), for example.

The communication interface 25 acquires driving information of the other vehicles 12 that are in the vicinity of the vehicle 12 by the vehicle-to-vehicle communication N2. The driving information includes, for example, the driving directions and driving speeds of the other vehicles 12 as well as the distance between the vehicle 12 and the other vehicles 12. In the first embodiment, the communication interface 25 acquires the driving information of the second vehicles 15 that are in the vicinity of the first vehicle 14 by, for example, the vehicle-to-vehicle communication N2 between the first vehicle 14 and the second vehicles 15 that are in the vicinity of the first vehicle 14.

The input/output interface 26 is an interface for communicating with each of the devices installed in the vehicle 12. The GPS device 31, the environment sensors 32, the internal sensors 33, the input devices 34, the actuators 35, the vital sensor 36, and the speaker 37 are connected via the input/output interface 26 to the vehicle control device 20. It will be noted that the GPS device 31, the environment sensors 32, the internal sensors 33, the input devices 34, the actuators 35, the vital sensor 36, and the speaker 37 may also be directly connected to the bus 29.

The GPS device 31 is a device that locates the current position of the vehicle 12. The GPS device 31 includes an antenna (not shown in the drawings) that receives signals from GPS satellites.

The environment sensors 32 are a group of sensors that detect environment information about the area around the vehicle 12. The environment sensors 32 include a camera 32A that images a predetermined range, a millimeter wave radar 32B that transmits exploration waves in a predetermined range and receives the reflected waves, a lidar (laser imaging detection and ranging) 32C that scans a predetermined range, and a drive recorder 32D that records the images captured by the camera 32A. It will be noted that it is preferable to have more than one camera 32A. In this case, a first camera 32A may be configured to capture an image in the forward direction of the vehicle 12, and a second camera 32A may be configured to capture an image in the rearward direction of the vehicle 12. Furthermore, one of the plural cameras 32A may be a visible light camera and the other may be an infrared camera.

The internal sensors 33 are a group of sensors that detect the driving state of the vehicle 12. The internal sensors 33 include at least one of a vehicle speed sensor, an acceleration sensor, and a yaw rate sensor.

The input devices 34 are a group of switches for the occupant riding in the vehicle 12 to operate. The input devices 34 include a steering wheel 34A serving as a switch that steers a steering wheel of the vehicle 12, an accelerator pedal 34B serving as a switch that accelerates the vehicle 12, and a brake pedal 34C serving as a switch that decelerates the vehicle 12.

The actuators 35 include a steering wheel actuator that drives the steering wheel of the vehicle 12, an accelerator actuator that controls the acceleration of the vehicle 12, and a brake actuator that controls the deceleration of the vehicle 12.

The vital sensor 36 detects the vital signs of the driver driving the vehicle 12. As the vital signs, any one or more of the heart rate, blood pressure, pulse, electrocardiogram, and pupils of the occupant are detected. In the first embodiment, as the vital sensor 36, any one or more of a heart rate sensor that detects the heart rate of the occupant of the vehicle 12, a blood pressure sensor that detects the blood pressure of the occupant, a pulse sensor that detects the pulse of the occupant, an electrocardiogram sensor that detects the electrocardiogram of the occupant, and a camera that images the pupils of the occupant are provided. The vital sensor 36 may be installed inside the vehicle 12 or may be a terminal (portable terminal, etc.) portably carried or worn by the driver of the vehicle 12.

The speaker 37 outputs, by audio, some of the information received by the vehicle-to-vehicle communication N2 or some of the information received from the remote center 17. In the first embodiment, for example, information of the first vehicle 14 that has been set as an urgent vehicle is received by the second vehicles 15 that are within a predetermined range around the first vehicle 14 via the vehicle-to-vehicle communication N2, whereby information indicating that the first vehicle 14 has been set as an urgent vehicle is output via audio. The predetermined range may, for example, be set as a circular range with a radius of 200 m, 400 m, 600 m, or 800 m centered on the first vehicle 14.

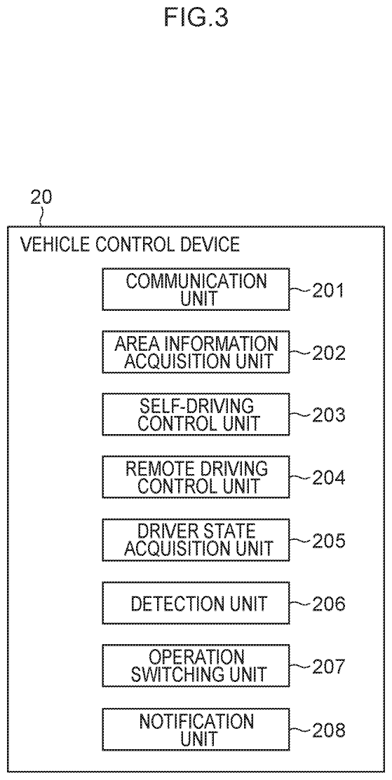

FIG. 3 is a block diagram showing an example of the functional configuration of the vehicle control device 20.

As shown in FIG. 3, the vehicle control device 20 has a communication unit 201, an area information acquisition unit 202, a self-driving control unit (namely, an autonomous driving control unit) 203, a remote driving control unit 204, a driver state acquisition unit 205, a detection unit 206, an operation switching unit 207, and a notification unit 208. The communication unit 201, the area information acquisition unit 202, the self-driving control unit 203, the remote driving control unit 204, the driver state acquisition unit 205, the detection unit 206, the operation switching unit 207, and the notification unit 208 are realized by the CPU 21 reading and executing the vehicle driving program stored in the ROM 22 or the storage 24.

The communication unit 201 performs communication with the other vehicles 12 and communication with the remote operation device 16.

The area information acquisition unit 202 acquires the area information about the area around the vehicle 12. The area information acquisition unit 202 acquires the area information about the area around the vehicle 12 from the environment sensors 32 via the input/output interface 26. Furthermore, the area information acquisition unit 202 receives the area information about the area around the vehicle 12 by the vehicle-to-vehicle communication N2. The area information includes information not only about the other vehicles 12 driving in the vicinity of the vehicle 12 and pedestrians but also the weather, brightness, road width, and obstacles. Furthermore, the area information includes information such as the driving directions, driving speeds, destinations, and driving routes of the other vehicles 12 driving in the vicinity of the vehicle 12 as well as the distances between the plural other vehicles 12. Moreover, the area information includes meteorological information such as temperature, wind speed, and rainfall, earthquake information such as seismic coefficient and tsunami information, and traffic information such as congestion, accidents, and road construction.

The self-driving control unit 203 creates a driving plan and, on the basis of the driving plan, controls the self-driving of the vehicle 12 driving autonomously. The self-driving control unit 203 controls the self-driving of the vehicle 12 in accordance with the area information acquired by the area information acquisition unit 202, the position information of the vehicle 12 acquired by the GPS device 31, and the driving information of the vehicle 12 acquired by the internal sensors 33. Examples of the driving information include the driving direction, driving speed, destination, and driving route of the vehicle 12 as well as the distance between the vehicle 12 and the other vehicles 12. The self-driving control unit 203 controls the acceleration, deceleration and steering of the vehicle 12 being driven in the self-driving mode.

The remote driving control unit 204 executes remote driving of the vehicle 12 on the basis of control information for performing remote driving that has been received from the remote operation device 16. In the first embodiment, in a case where the first vehicle 14 has been set as an urgent vehicle, the control information for performing remote driving is transmitted to the first vehicle 14 from the remote operation device 16, and the remote driving control unit 204 executes remote driving of the first vehicle 14.

The driver state acquisition unit 205 acquires information relating to the state of the driver of the vehicle 12. The driver state acquisition unit 205 is an example of an acquisition unit. In the first embodiment, the driver state acquisition unit 205 acquires the information relating to the state of the driver of the first vehicle 14 being driven in the manual driving mode. The information relating to the state of the driver of the first vehicle 14 includes, for example, the vital signs of the driver of the first vehicle 14 acquired by the vital sensor 36 inside the first vehicle 14. Furthermore, the information relating to the state of the driver of the first vehicle 14 includes, for example, information relating to the state of the driver of the first vehicle 14 captured by the drive recorders 32D of the second vehicles 15 driving in front and in back of the first vehicle 14.

The detection unit 206 detects, by means of the information relating to the state of the driver of the first vehicle 14, that the driver is in a condition in which it is difficult to drive. In the first embodiment, for example, the detection unit 206 detects, on the basis of the vital signs of the driver of the first vehicle 14 acquired by the vital sensor 36 inside the first vehicle 14, that the driver of the first vehicle 14 is in a condition in which it is difficult to drive. As the vital signs, as described above, any one or more of the heart rate, blood pressure, pulse, electrocardiogram, and pupils of the driver are detected. For example, thresholds are set for each of the heart rate, blood pressure, pulse, electrocardiogram, and pupils of the driver, and the detection unit 206 detects that the driver of the vehicle 12 is in a condition in which it is difficult to drive when any of the vital signs acquired is equal to or greater than its threshold. Furthermore, for example, the detection unit 206 detects, on the basis of the information relating to the state of the driver of the first vehicle 14 captured by the drive recorders 32D of the second vehicles 15 driving in front and in back of the first vehicle 14, that the driver of the first vehicle 14 is in a condition in which it is difficult to drive.

The operation switching unit 207 switches the vehicle 12 to any of the manual driving mode, the self-driving mode, and the remote driving mode on the basis of a driving mode input signal. There are cases where the operation switching unit 207 switches the driving mode as a result of the occupant of the vehicle 12 inputting (e.g., including also selecting) the driving mode and cases where the operation switching unit 207 switches the driving mode to the remote driving mode on the basis of a switch signal from the remote operation device 16.

The notification unit 208, in a case where the first vehicle 14 has been switched to the remote driving mode in accordance with the information relating to the state of the driver of the first vehicle 14, notifies the occupants inside the second vehicles 15 located within the predetermined range from the first vehicle 14 of the presence of the first vehicle 14 that has been set as an urgent vehicle.

(Remote Operation Device)

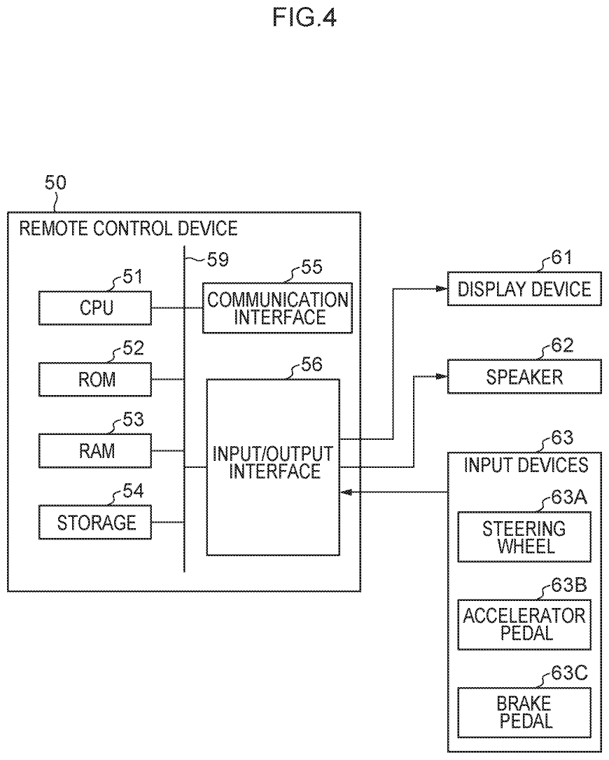

FIG. 4 is a block diagram showing the hardware configuration of devices installed in the remote operation device 16. The remote operation device 16 has, in addition to the remote control device 50, a display device 61, a speaker 62, and input devices 63.

The remote control device 50 is configured to include a CPU 51, a ROM 52, a RAM 53, a storage 54, a communication interface 55, and an input/output interface 56. The CPU 51, the ROM 52, the RAM 53, the storage 54, the communication interface 55, and the input/output interface 56 are communicably connected to each other via a bus 59. The functions of the CPU 51, the ROM 52, the RAM 53, the storage 54, the communication interface 55, and the input/output interface 56 are the same as those of the CPU 21, the ROM 22, the RAM 23, the storage 24, the communication interface 25, and the input/output interface 26 of the vehicle control device 20.

The CPU 51 reads programs from the ROM 52 or the storage 54 and executes the programs using the RAM 53 as a work area. In the first embodiment, a vehicle driving program is stored in the ROM 52 or the storage 54.

The display device 61, the speaker 62, and the input devices 63 are connected via the input/output interface 56 to the remote control device 50 of the first embodiment. It will be noted that the display device 61, the speaker 62, and the input devices 63 may also be directly connected to the bus 59.

The display device 61 is a liquid crystal monitor for displaying the images captured by the cameras 32A of the vehicles 12 and various types of information pertaining to the vehicles 12.

The speaker 62 plays back audio that has been recorded together with the images by microphones (not shown in the drawings) belonging to the cameras 32A of the vehicles 12.

The input devices 63 are controllers for the remote driver utilizing the remote operation device 16 to operate. The input devices 63 include a steering wheel 63A serving as a switch that steers steering wheels of the vehicles 12, an accelerator pedal 63B serving as a switch that accelerates the vehicles 12, and a brake pedal 63C serving as a switch that decelerates the vehicles 12. It will be noted that the configurations of each of the input devices 63 are not limited. For example, a lever switch may also be provided instead of the steering wheel 63A. Furthermore, for example, a push button switch and/or a lever switch may also be provided instead of the accelerator pedal 63B and/or the brake pedal 63C.

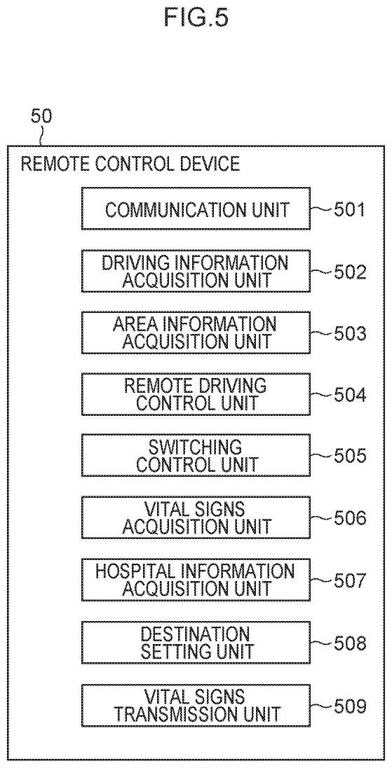

FIG. 5 is a block diagram showing an example of the functional configuration of the remote control device 50.

As shown in FIG. 5, the remote control device 50 has a communication unit 501, a driving information acquisition unit 502, an area information acquisition unit 503, a remote driving control unit 504, a switching control unit 505, a vital signs acquisition unit 506, a hospital information acquisition unit 507, a destination setting unit 508, and a vital signs transmission unit 509.

The communication unit 501 performs communication with the vehicle 12 utilizing remote driving (e.g., the first vehicle 14). The images and audio of the camera 32A transmitted from the vehicle control device 20 and vehicle information such as vehicle speed are received by the communication unit 501. The received images and vehicle information are displayed on the display device 61, and the audio information is output from the speaker 62.

The driving information acquisition unit 502 acquires the driving information of the vehicle 12 utilizing remote driving (e.g., the first vehicle 14).

The area information acquisition unit 503 acquires the area information about the area around the vehicle 12 utilizing remote driving (e.g., the first vehicle 14).

The remote driving control unit 504, in a case where remote driving based on operation by the remote driver is performed, controls the remote driving of the vehicle 12 by transmitting control information for performing remote driving via the communication unit 501 to the vehicle control device 20 on the basis of signals input from each of the input devices 63.

The switching control unit 505 controls the switching of the vehicle 12 to the remote driving mode. The switching control unit 505 switches the vehicle 12 from the self-driving mode or the manual driving mode to the remote driving mode by outputting a switch signal to the vehicle control device 20 of the vehicle 12. In the first embodiment, in a case where it has been verified that it is difficult for the driver of the first vehicle 14 being driven in the manual driving mode to drive, the switching control unit 505 performs control to switch the first vehicle 14 from the manual driving mode to the remote driving mode.

The vital signs acquisition unit 506, in a case where the first vehicle 14 has been set as an urgent vehicle, acquires the vital signs of the driver of the first vehicle 14 (i.e., the occupant seated in the driver's seat after the first vehicle 14 has been switched to the remote driving mode).

The hospital information acquisition unit 507 acquires information about the hospitals 68 capable of admitting the driver within the predetermined range from the first vehicle 14 in accordance with the vital signs of the driver of the first vehicle 14. The predetermined range is, for example, set as a circular range 2 km, 4 km, 6 km, 8 km, or 10 km from the first vehicle 14.

The destination setting unit 508 sets, in accordance with the information about the hospitals 68 capable of admitting the driver acquired by the hospital information acquisition unit 507, the destination of the first vehicle 14 to one hospital 68 (i.e., an admitting hospital) capable of admitting the driver. The one hospital 68 is, for example, set in accordance with the driving distances and driving times from the first vehicle 14 to each of the hospitals 68.

The vital signs transmission unit 509 transmits the vital signs of the driver of the first vehicle 14 to the one hospital 68 (i.e., the admitting hospital) that was set by the destination setting unit 508.

(Flow of Control)

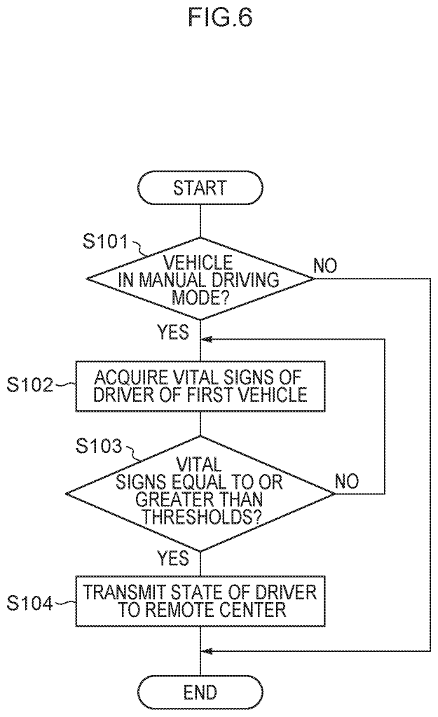

Next, the action of the vehicle driving system 10 will be described. It will be noted that in order to arrange the action in a time series, a first action of the vehicle control device 20 of the vehicles 12, the action of the remote control device 50, and a second action of the vehicle control device 20 of the vehicles 12 will be sequentially described using FIG. 6 to FIG. 8.

FIG. 6 is a flowchart showing the flow of a first driving process performed by the vehicle control device 20. In the flowchart shown in FIG. 6, an example of acquiring the vital signs of the driver of the vehicle 12 is shown. The first driving process is performed by the CPU 21 reading the vehicle driving program from the ROM 22 or the storage 24, transferring it to the RAM 23, and executing it.

When the driver of the vehicle 12 starts driving, in step S101 the CPU 21 judges whether or not the vehicle 12 is being driven in the manual driving mode. In the first embodiment, in a case where the vehicle 12 is being driven in the manual driving mode, the vehicle 12 is the first vehicle 14 being driven in the manual driving mode, so in subsequent steps the vehicle 12 will be called “the first vehicle 14” as needed.

In a case where the vehicle 12 is being driven in the manual driving mode (i.e., in the case of YES in step S101), in step S102 the CPU 21 acquires the vital signs of the driver of the first vehicle 14 being driven in the manual driving mode. In the first embodiment, any one or more vital signs such as the heart rate, blood pressure, pulse, electrocardiogram, and pupils of the occupant of the first vehicle 14 are detected by the vital sensor 36 inside the first vehicle 14.

In a case where the vehicle 12 is not being driven in the manual driving mode (i.e., in the case of NO in step S101), the CPU 21 ends the first driving process based on the vehicle driving program.

In step S103 the CPU 21 judges whether or not the vital signs of the driver of the first vehicle 14 being driven in the manual driving mode are equal to or greater than thresholds. In the first embodiment, the thresholds are set in regard to any one or more of the heart rate, blood pressure, pulse, electrocardiogram, and pupils of the occupant. When any one of the vital signs is equal to or greater than its threshold, it is judged that the vital signs are equal to or greater than the thresholds. In the first embodiment, the thresholds are numerical values of vital signs by which it is supposed that the driver of the vehicle 12 is in a condition in which it is difficult to drive, and in a case where the vital signs are equal to or greater than the thresholds, it is detected that the driver of the vehicle 12 is in a condition in which it is difficult to drive.

In a case where the vital signs of the driver of the first vehicle 14 are not equal to or greater than the thresholds (i.e., in the case of NO in step S103), the CPU 21 returns to the process of step S102.

In a case where the vital signs of the driver of the first vehicle 14 are equal to or greater than the thresholds (i.e., in the case of YES in step S103), in step S104 the CPU 21 transmits information relating to the state of the driver of the first vehicle 14 to the remote operation device 16 of the remote center 17. In the first embodiment, as the information relating to the state of the driver, the CPU 21 transmits the vital signs of the driver and an indication that the vital signs are abnormal to the remote operation device 16 of the remote center 17. With this, the CPU 21 ends the first driving process based on the vehicle driving program.

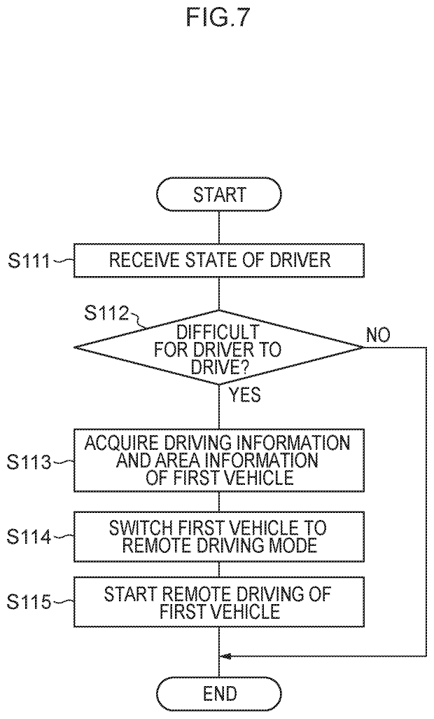

FIG. 7 is a flowchart showing the flow of a first driving process performed by the devices installed in the remote operation device 16. The first driving process is performed by the CPU 51 reading the vehicle driving program from the ROM 52 or the storage 54, transferring it to the RAM 53, and executing it.

In step S111, the CPU 51 receives the information relating to the state of the driver of the first vehicle 14. As the information relating to the state of the driver, for example, the CPU 51 receives from the first vehicle 14 the vital signs of the driver of the first vehicle 14 and the indication that the vital signs are abnormal (see step S104 shown in FIG. 6).

In step S112 the CPU 51 judges, on the basis of the information relating to the state of the driver of the first vehicle 14, whether or not it is difficult for the driver of the first vehicle 14 to drive. In the first embodiment, in a case where the vital signs of the driver of the first vehicle 14 are equal to or greater than the thresholds described in step S103 shown in FIG. 6, the CPU 51 judges that it is difficult for the driver of the first vehicle 14 to drive. It will be noted that the CPU 51 may also judge that it is difficult for the driver of the first vehicle 14 to drive in a case where second thresholds stricter than the thresholds described in step S103 shown in FIG. 6 have been set and the vital signs of the driver of the first vehicle 14 are equal to or greater than the second thresholds. In the first embodiment, the CPU 51 sets the first vehicle 14 as an urgent vehicle in a case where it is difficult for the driver of the first vehicle 14 to drive.

In a case where it is not difficult for the driver of the first vehicle 14 to drive (i.e., in the case of NO in step S112), the CPU 51 ends the first driving process based on the vehicle driving program.

In a case where it is difficult for the driver of the first vehicle 14 to drive (i.e., in the case of YES in step S112), in step S113 the CPU 51 acquires the driving information of the first vehicle 14 and the area information about the area around the first vehicle 14. In the first embodiment, the CPU 51 acquires the driving information of the first vehicle 14 and the area information about the area around the first vehicle 14 via the network N1 from the first vehicle 14.

In step S114 the CPU 51 switches the first vehicle 14 from the manual driving mode to the remote driving mode.

In step S115 the CPU 51 starts remote driving of the first vehicle 14 in accordance with the driving information of the first vehicle 14 and the area information about the area around the first vehicle 14. With this, the CPU 51 ends the first driving process based on the vehicle driving program.

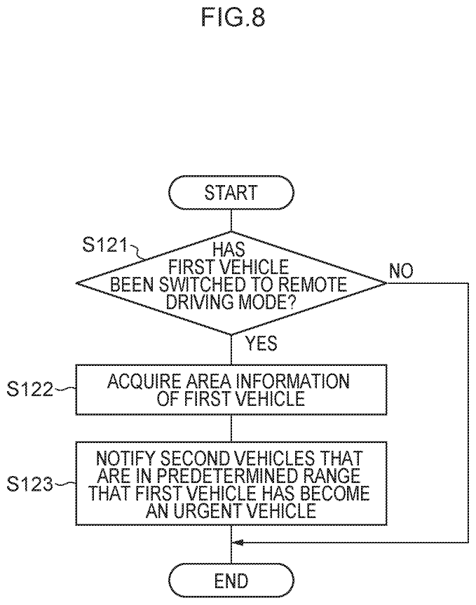

FIG. 8 is a flowchart showing the flow of a second driving process performed by the vehicle control device 20 of the first vehicle 14. The second driving process is performed by the CPU 21 reading the vehicle driving program from the ROM 22 or the storage 24, transferring it to the RAM 23, and executing it.

In step S121 the CPU 21 judges whether or not the first vehicle 14 has been switched to the remote driving mode.

In a case where the first vehicle 14 has been switched to the remote driving mode (i.e., in the case of YES in step S121), in step S122 the CPU 21 acquires the area information about the area around the first vehicle 14.

In a case where the first vehicle 14 has not been switched to the remote driving mode (i.e., in the case of NO in step S121), the CPU 21 ends the second driving process based on the vehicle driving program.

In step S123 the CPU 21 notifies the second vehicles 15 that are within the predetermined range around the first vehicle 14 of information indicating that the first vehicle 14 has been set as an urgent vehicle. The notification given from the first vehicle 14 to the second vehicles 15 is performed by the vehicle-to-vehicle communication N2 between the first vehicle 14 and the second vehicles 15. It will be noted that the notification given from the first vehicle 14 to the second vehicles 15 may also be performed via the network N1. The predetermined range is, for example, set as a circular range with a radius of 200 m, 400 m, 600 m, or 800 m centered on the first vehicle 14. For example, if there are second vehicles 15 being driven in the manual driving mode in the vicinity of the first vehicle 14, there are cases where the driving of the first vehicle 14 will be obstructed. The predetermined range is preset as a range in which, by moving out of the way of the first vehicle 14, the second vehicles 15 will not obstruct the driving of the first vehicle 14.

In the first embodiment, when the CPU 21 notifies the second vehicles 15 of the information indicating that the first vehicle 14 has been set as an urgent vehicle, the CPU 21 notifies the second vehicles 15 that they need to move out of the driving direction of the first vehicle 14. The information notifying the second vehicles 15 that they need to move out of the way may be output by audio from the speakers 37 in the second vehicles 15, or may be output by characters or the like on a display unit (not shown in the drawings) in the second vehicles 15. With this, the CPU 21 ends the second driving process based on the vehicle driving program.

As shown in FIG. 9, in the vehicle driving system 10, when the first vehicle 14 that has been set as an urgent vehicle is being driven in the remote driving mode on the road 66, the second vehicles 15 that are within the predetermined range around the first vehicle 14 are notified that they need to move out of the driving direction of the first vehicle 14. Because of this, it becomes possible to drive or stop the second vehicles 15 so as to move them out of the driving direction of the first vehicle 14. For this reason, the first vehicle 14 that has been set as an urgent vehicle can be driven swiftly and smoothly in the remote driving mode.

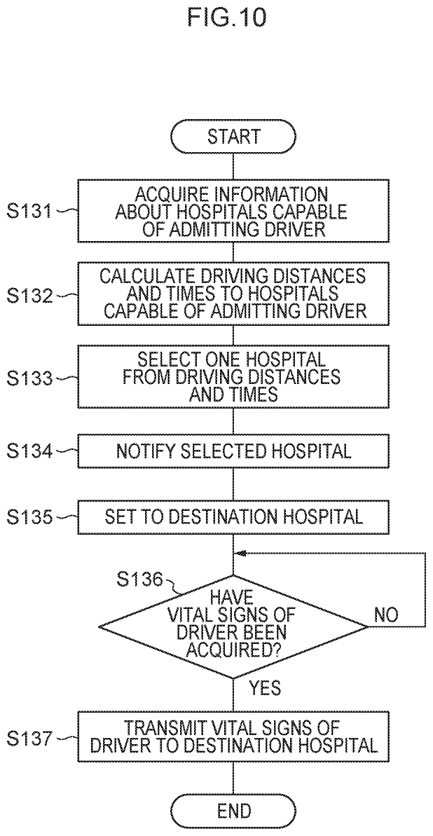

FIG. 10 is a flowchart showing the flow of a second driving process performed by the devices installed in the remote operation device 16. The second driving process is performed by the CPU 51 reading the vehicle driving program from the ROM 52 or the storage 54, transferring it to the RAM 53, and executing it. The second driving process of the flowchart shown in FIG. 10 is performed after the first driving process of the flowchart shown in FIG. 7.

In step S131 the CPU 51 acquires the information about the plural hospitals 68 capable of admitting the driver of the first vehicle 14. The information about the plural hospitals 68 capable of admitting the driver is acquired via the network N1.

In step S132 the CPU 51 calculates the driving distances and times to the plural hospitals 68 capable of admitting the driver.

In step S133 the CPU 51 selects one of the hospitals 68 from the driving distances and times to the plural hospitals 68 capable of admitting the driver.

In step S134 the CPU 51 notifies the one hospital 68 it selected in step S133 that the driver of the first vehicle 14 is being transported there.

In step S135 the CPU 51 sets the hospital 68 it has notified as an admitting destination hospital (i.e., admitting hospital) 68.

In step S136 the CPU 51 judges whether or not it has acquired the vital signs of the driver of the first vehicle 14 (i.e., the occupant seated in the driver's seat after the first vehicle 14 has been switched to the remote driving mode). In a case where it has not acquired the vital signs of the driver (i.e., in the case of NO in step S136), the CPU 51 stands by until it acquires the vital signs of the driver.

In a case where it has acquired the vital signs of the driver (i.e., in the case of YES in step S136), in step S137 the CPU 51 transmits the vital signs of the driver to the destination hospital 68. With this, the CPU 51 ends the second driving process based on the vehicle driving program.

In the vehicle driving system 10 of the first embodiment, the CPU 51 sets, in accordance with the information about the hospitals 68 capable of admitting the driver, the destination of the first vehicle 14 to the admitting hospital 68 capable of admitting the driver. For this reason, the driver can be transported to the admitting hospital 68 at an early stage. Furthermore, in the vehicle driving system 10, the CPU 51 transmits the vital signs of the driver to the admitting hospital 68, so the vital signs of the driver can be transmitted to the admitting hospital 68 before the first vehicle 14 reaches the admitting hospital 68 by being driven in the remote driving mode.

It will be noted that instead of step S134 in the flowchart shown in FIG. 10 the CPU 51 may perform control to verify whether or not the hospital it selected is capable of admitting the driver and, in a case where it has been verified that the hospital is capable of admitting the driver, transition to step S135. It will be noted that in a case where the hospital it selected is not capable of admitting the driver, the CPU 51 may perform control to return to step S133 and select another hospital other than that hospital.

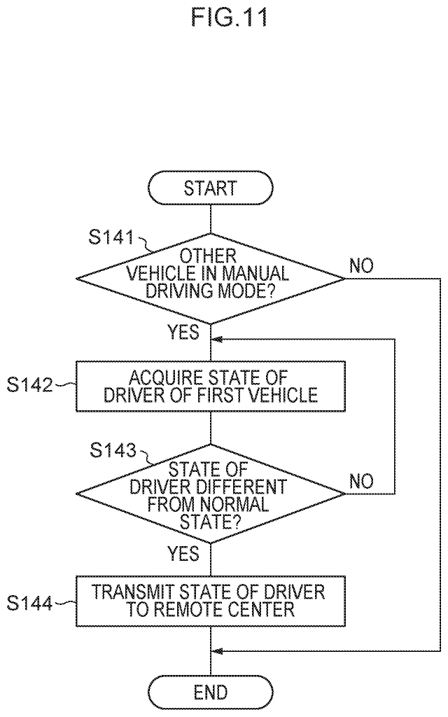

FIG. 11 is a flowchart showing the flow of a third driving process performed by the vehicle control devices 20 of the second vehicles 15. In the flowchart shown in FIG. 11, an example is shown where the second vehicles 15 driving in front and in back of the first vehicle 14 acquire the information relating to the state of the driver of the first vehicle 14. The third driving process is performed by the CPU 21 reading the vehicle driving program from the ROM 22 or the storage 24, transferring it to the RAM 23, and executing it. The third driving process of the flowchart shown in FIG. 11 is performed independently of the first driving process of the flowchart shown in FIG. 6 (i.e., without being associated with the first driving process).

In step S141 the CPU 21 judges whether or not another vehicle 12 in the vicinity of the second vehicle 15 is being driven in the manual driving mode. Information indicating whether the other vehicles 12 are being driven in the manual driving mode, the remote driving mode, or the self-driving mode is acquired from the driving information of the other vehicles 12 obtained by the environment sensors 32 of the second vehicle 15. Here, “in the vicinity of the second vehicle 15” means a range in which the driving states of the other vehicles 12 are acquirable by the environment sensors 32 of the second vehicle 15. In the first embodiment, in a case where another vehicle 12 is being driven in the manual driving mode, the other vehicle 12 is the first vehicle 14 being driven in the manual driving mode, so in subsequent steps the other vehicle 12 will be called “the first vehicle 14” as necessary.

In a case where another vehicle 121 is being driven in the manual driving mode (i.e., in the case of YES in step S141), in step S142 the CPU 21 acquires the state of the driver of the first vehicle 14 being driven in the manual driving mode. In the first embodiment, information relating to the state of the driver of the first vehicle 14 is acquired, in accordance with the driving information relating to the driving state of the first vehicle 14, by the drive recorder 32D provided in the second vehicle 15 driving in front or in back of the first vehicle 14.

In a case where another vehicle 12 is not being driven in the manual driving mode (i.e., in the case of NO in step S141), the CPU 21 ends the third driving process based on the vehicle driving program.

In step S143 the CPU 21 judges whether or not the state of the driver of the first vehicle 14 being driven in the manual driving mode is different from a normal state. In the first embodiment, driving information relating to a driving state when the driver of another vehicle 12 is a normal state is stored in the ROM 22 or the storage 24. The CPU 21 compares the driving state of the first vehicle 14 to the driving information relating to the driving state when the driver is in a normal state and, in a case where the driving state of the first vehicle 14 is outside an allowable range, judges that the state of the driver of the first vehicle 14 is different from a normal state. The CPU 21 judges that the state of the driver is different from a normal state, for example, in a case where the first vehicle 14 has meandered, a case where the first vehicle 14 has strayed outside its driving lane, or a case where the first vehicle 14 is driving unstably and is such about to stray outside its driving lane.

In a case where the state of the driver is not different from a normal state (i.e., in the case of NO in step S143), the CPU 21 returns to the process of step S142.

In a case where the state of the driver is different from a normal state (i.e., in the case of YES in step S143), in step S144 the CPU 21 transmits information relating to the state of the driver of the first vehicle 14 to the remote operation device 16 of the remote center 17. In the first embodiment, as the information relating to the state of the driver, the CPU 21 transmits information indicating that the state of the driver is different from a normal state to the remote operation device 16 of the remote center 17. With this, the CPU 21 ends the third driving process based on the vehicle driving program.

Thereafter, the remote control device 50 of the remote operation device 16 performs the first driving process of the flowchart shown in FIG. 7. At that time, in step S111 shown in FIG. 7, the CPU 51 receives, from the second vehicle 15 as the information relating to the state of the driver of the first vehicle 14, the information indicating that the state of the driver of the first vehicle 14 is different from a normal state. Furthermore, in step S112 shown in FIG. 7, the CPU 51 judges, on the basis of the information indicating that the state of the driver of the first vehicle 14 is different from a normal state, whether or not it is difficult for the driver of the first vehicle 14 to drive. In a case where it is difficult for the driver of the first vehicle 14 to drive, the CPU 21 sets the first vehicle 14 as an urgent vehicle and transitions to step S113.

In the vehicle driving system 10 of the first embodiment, by utilizing the drive recorders 32D provided in the second vehicles 15 driving in front and in back of the first vehicle 14, information relating to the state of the driver of the first vehicle 14 can be acquired. For this reason, in the vehicle driving system 10, it is possible to lower costs compared to the case of providing a new acquisition unit outside the second vehicles 15.

### Second Embodiment

Next, a vehicle driving system 70 pertaining to a second embodiment will be described. It will be noted in regard to constituent parts that are identical to those in the first embodiment that identical numbers are assigned thereto and description thereof will be omitted.

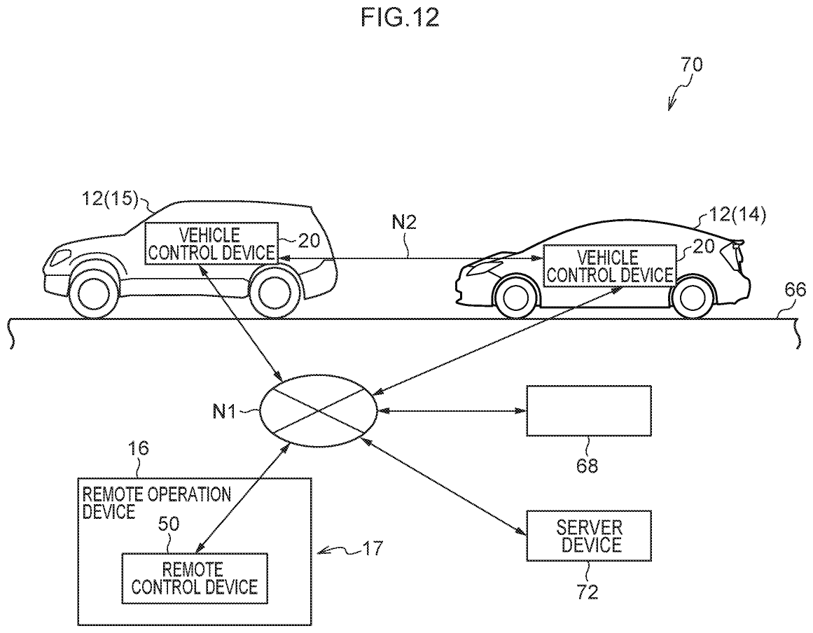

FIG. 12 is a drawing showing the schematic configuration of the vehicle driving system 70 pertaining to the second embodiment.

As shown in FIG. 12, the vehicle driving system 70 is configured to include plural vehicles 12, a remote operation device 16 provided in a remote center 17, plural hospitals 68, and a server device 72. The plural vehicles 12 include a first vehicle 14 that is driven in a manual driving mode and a second vehicle 15 that is driving in the vicinity of the first vehicle 14. In the vehicle driving system 70, the vehicle control device 20 of the first vehicle 14, the vehicle control device 20 of the second vehicle 15, the remote control device 50 of the remote operation device 16, the plural hospitals 68, and the server device 72 are connected to each other via a network N1.

(Server Device)

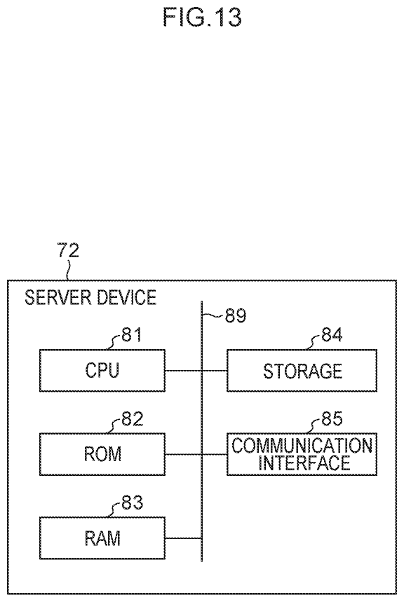

FIG. 13 is a block diagram showing the hardware configuration of devices installed in the server device 72.

As shown in FIG. 13, the server device 72 is configured to include a CPU 81, a ROM 82, a RAM 83, a storage 84, and a communication interface (I/F) 85. The CPU 81, the ROM 82, the RAM 83, the storage 84, and the communication interface 85 are communicably connected to each other via a bus 89. The functions of the CPU 81, the ROM 82, the RAM 83, the storage 84, and the communication interface 85 are the same as those of the CPU 21, the ROM 22, the RAM 23, the storage 24, and the communication interface 25 of the vehicle control device 20 (see FIG. 2).

The CPU 81 reads programs from the ROM 82 or the storage 84 and executes the programs using the RAM 83 as a work area. In the second embodiment, a vehicle driving program is stored in the ROM 82 or the storage 84.

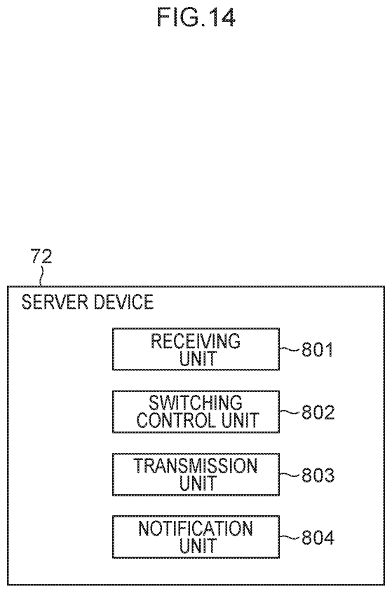

FIG. 14 is a block diagram showing an example of the functional configuration of the server device 72.

As shown in FIG. 14, the server device 72 has a receiving unit 801, a switching control unit 802, a transmission unit 803, and a notification unit 804. The receiving unit 801, the switching control unit 802, the transmission unit 803, and the notification unit 804 are realized by the CPU 81 reading and executing the vehicle driving program stored in the ROM 82 or the storage 84.

The receiving unit 801 receives, from the plural vehicles 12, the area information of the respective vehicles 12. Furthermore, the receiving unit 801 receives the driving information relating to the driving states of the plural vehicles 12. In the second embodiment, the receiving unit 801 receives the area information about the area around the first vehicle 14 that has been set as an urgent vehicle and the driving information relating to the driving state of the first vehicle 14.

The switching control unit 802 controls the switching of the second vehicles 15 that are in the vicinity of first vehicle 14 (in the second embodiment, within the predetermined range of the first vehicle 14) that has been set as an urgent vehicle to the remote driving mode. The switching control unit 802 is an example of another switching control unit. The switching control unit 802 performs control to switch the second vehicles 15 from the manual driving mode or the self-driving mode to the remote driving mode by outputting a switch signal to the vehicle control devices 20 of the second vehicles 15. The predetermined range is, for example, set as a circular range with a radius of 200 m, 400 m, 600 m, or 800 m centered on the first vehicle 14.

The transmission unit 803 transmits, to the remote operation device 16, the area information about the area around the first vehicle 14 that has been set as an urgent vehicle and the driving information relating to the driving state of the first vehicle 14. Moreover, the transmission unit 803 transmits, to the remote operation device 16, the driving information relating to the driving state of the second vehicles 15 utilizing the remote driving mode. The driving information includes, for example, information such as the driving directions, driving speeds, destinations, and driving routes of the first vehicle 14 and the second vehicles 15 as well as the distances between the first vehicle 14 and the second vehicles 15.

The notification unit 804 notifies the occupants inside the second vehicles 15 that are in the vicinity of the first vehicle 14 (in the second embodiment, in the predetermined range of the first vehicle 14) that has been set as an urgent vehicle of the presence of the first vehicle 14 that has been set as an urgent vehicle. The notification unit 804 notifies, via the transmission unit 803, the occupants inside the second vehicles 15 of the presence of the first vehicle 14 that has been set as an urgent vehicle. The occupants inside the second vehicles 15 are notified of the presence of the first vehicle 14 that has been set as an urgent vehicle by, for example, audio that is output from the speakers 37 (see FIG. 2).

In the vehicle driving system 70 of the second embodiment, information indicating that the first vehicle 14 has been set as an urgent vehicle is transmitted from the remote operation device 16 to the server device 72 after the first driving process (see FIG. 7) has been performed by the remote operation device 16 of the vehicle driving system 10 of the first embodiment.

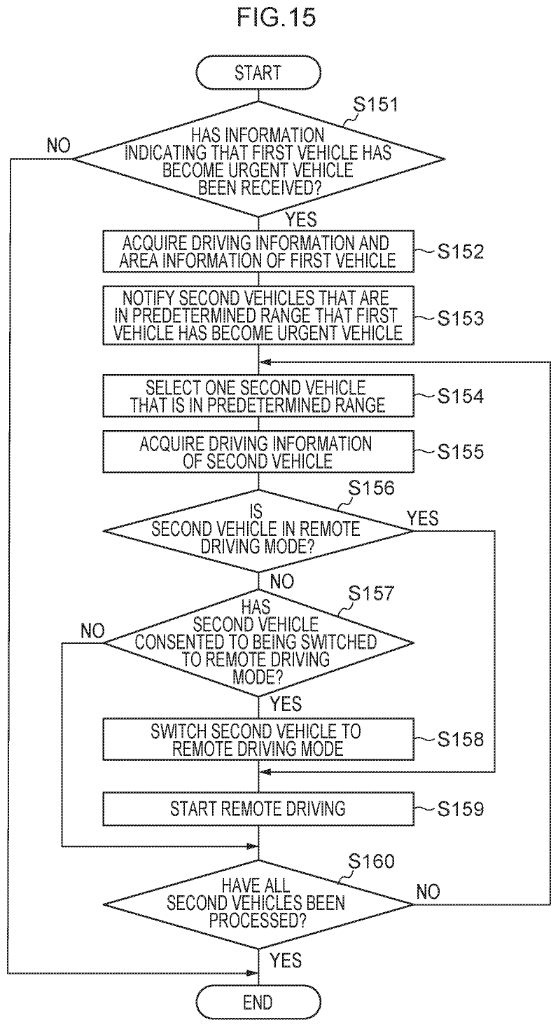

In the vehicle driving system 70 of the second embodiment, a driving process performed by the server device 72 shown in FIG. 15 is performed instead of the second driving process (see FIG. 8) performed by the vehicle control device 20 of the first vehicle 14 of the vehicle driving system 10 of the first embodiment.

FIG. 15 is a flowchart showing the flow of the driving process performed by the devices installed in the server device 72. The driving process is performed by the CPU 81 reading the vehicle driving program from the ROM 82 or the storage 84, transferring it to the RAM 83, and executing it.

In step S151 the CPU 81 judges whether or not information indicating that the first vehicle 14 has been set as an urgent vehicle has been received.

In a case where the information indicating that the first vehicle 14 has been set as an urgent vehicle has been received (i.e., in the case of YES in step S151), in step S152 the CPU 81 acquires the driving information of the first vehicle 14 and the area information about the area around the first vehicle 14.

In a case where the information indicating that the first vehicle 14 has been set as an urgent vehicle has not been received (i.e., in the case of NO in step S151), the CPU 81 ends the driving process based on the vehicle driving program.

In step S153 the CPU 81 notifies the second vehicles 15 that are in the predetermined range of the first vehicle 14 of the information that the first vehicle 14 has been set as an urgent vehicle. In the second embodiment, the notification given from the server device 72 to the second vehicles 15 is performed via the network N1.

In step S154 the CPU 81 selects one of the second vehicles 15 that are in the predetermined range around the first vehicle 14 that has been set as an urgent vehicle.

In step S155 the CPU 81 acquires the driving information of the one second vehicle 15 that was selected in step S154.

In step S156 the CPU 81 judges whether or not the one second vehicle 15 that was selected in step S154 is being driven in the remote driving mode.

In a case where the one second vehicle 15 that was selected is not being driven in the remote mode (i.e., in the case of NO in step S156), in step S157 the CPU 81 judges whether or not the second vehicle 15 has consented to being switched to the remote driving mode. In the second embodiment, the CPU 81 requests the second vehicle 15 to be switched to the remote driving mode and judges whether or not the second vehicle 15 has consented to being switched to the remote driving mode.

In a case where the one second vehicle 15 that was selected is being driven in the remote mode (i.e., in the case of YES in step S156), the CPU 81 proceeds to the process of step S159.

In a case where the one second vehicle 15 that was selected has consented to being switched to the remote driving mode (i.e., in the case of YES in step S157), in step S158 the CPU 81 switches the second vehicle 15 to the remote driving mode. For example, in a case where the one second vehicle 15 that was selected is being driven in the manual driving mode or the self-driving mode, the second vehicle 15 is switched from the manual driving mode or the self-driving mode to the remote driving mode.

In a case where the one second vehicle 15 that was selected will not consent to being switched to the remote driving mode (i.e., in the case of NO in step S157), the CPU 81 proceeds to the process of step S160.

In step S159 the CPU 81 starts remote driving of the one second vehicle 15 that was selected. For example, the CPU 81 drives the second vehicle 15 in the remote driving mode so as to move it out of the way of the first vehicle 14 that has been set as an urgent vehicle. At this time, the driving of the first vehicle 14 that has been set as an urgent vehicle and the second vehicle 15 that is in the vicinity of the first vehicle 14 may be displayed in a bird's-eye view on the display device 61 of the remote operation device 16. Because of this, the second vehicle 15 can be driven or stopped in the remote driving mode so as to move it out of the way of the first vehicle 14 in accordance with the driving information (destination, driving route, etc.) of the first vehicle 14 that has been set as an urgent vehicle.

In step S160 the CPU 81 judges whether or not it has processed all the second vehicles 15 that are in the predetermined range of the first vehicle 14.

In a case where it has not processed all the second vehicles 15 (i.e., in the case of NO in step S160), the CPU 81 returns to the process of step S154.

In a case where it has processed all the second vehicles 15 (i.e., in the case of YES in step S160), the CPU 81 ends the driving process based on the vehicle driving program.

In the vehicle driving system 70 of the second embodiment, by notifying the second vehicles 15 that are in the predetermined range of the first vehicle 14 that has been set as an urgent vehicle of the information indicating that the first vehicle 14 has been set as an urgent vehicle and switching the second vehicles 15 to the remote driving mode, the second vehicles 15 can be smoothly moved out of the way of the first vehicle 14.

Vehicle driving systems of the first and second embodiments have been described above. However, the disclosure is not limited to the above embodiments. Various improvements to and modifications thereof are possible.

In the vehicle driving system 10 of the first embodiment, the information relating to the state of the driver of the first vehicle 14 is acquired by the vital sensor 36 inside the first vehicle 14, and the information relating to the state of the driver of the first vehicle 14 is acquired by the drive recorders 32D provided in the second vehicles 15, but the disclosure is not limited to this. For example, the vehicle driving system may also be configured in such a way that the information relating to the state of the driver of the first vehicle 14 is acquired by just the vital sensor 36 inside the first vehicle 14.

In the vehicle driving systems 10 and 70 of the first and second embodiments, the configuration of the driver state acquisition unit 205 that acquires the information relating to the state of the driver of the vehicle 12 can be changed. For example, in addition to the driver state acquisition unit 205 of the first and second embodiments, acquisition units may also be provided at predetermined intervals on the road 66 so that the information relating to the state of the driver of the vehicle 12 is acquired by the acquisition units.

In the vehicle driving system 70 of the second embodiment, the remote control device 50 performs, among other things, acquisition of the information about the hospitals 68 capable of admitting the driver of the first vehicle 14, but the disclosure is not limited to this. For example, the vehicle driving system may also be configured in such a way that, instead of the remote control device 50, the server device 72 acquires the information about the hospitals 68 capable of admitting the driver of the first vehicle 14, and the server device 72 performs processes such as notifying the admitting hospital 68 that the driver of the first vehicle 14 is being transported there and transmitting to the admitting hospital 68 the vital signs of the driver of the first vehicle 14.

It will be noted that although in the vehicle driving system 10 of the first embodiment the remote control device 50 switches the first vehicle 14 from the manual driving mode to the remote driving mode in a case where it is difficult for the driver of the first vehicle 14 to drive, the disclosure is not limited to this. For example, the vehicle driving system may also be configured in such a way that, in a case where it is difficult for the driver of the first vehicle 14 to drive, the vehicle control device 20 of the first vehicle 14 confirms with the remote operation device 16 whether or not it is capable of performing remote driving and, after a confirmation from the remote operation device 16 has been obtained, switches the first vehicle 14 from the manual driving mode to the remote driving mode.

It will be noted that in each of the above embodiments various types of processors other than a CPU may also execute the vehicle driving process that the CPUs 21, 51, and 81 execute by reading software (e.g., programs). Examples of processors in this case include programmable logic devices (PLDs) whose circuit configuration can be changed after manufacture, such as field-programmable gate arrays (FPGAs), and dedicated electrical circuits that are processors having a circuit configuration dedicatedly designed for executing specific processes, such as application-specific integrated circuits (ASICs). Furthermore, the vehicle driving process may be executed by one of these various types of processors or may be executed by a combination of two or more processors of the same type or different types (e.g., plural FPGAs, and a combination of a CPU and an FPGA, etc.). Furthermore, the hardware structures of these various types of processors are more specifically electrical circuits in which circuit elements such as semiconductor elements are combined.

Furthermore, in each of the above embodiments, configurations where the vehicle driving programs are stored (e.g., installed) beforehand in the ROMs 22, 52, and 82 or the storages 24, 54, and 84 were described, but the vehicle driving system is not limited to this. The programs may also be provided in forms in which they are recorded in a recording medium such as a compact disc read-only memory (CD-ROM), a digital versatile disc read-only memory (DVD-ROM), and a universal serial bus (USB) memory. Furthermore, the programs may also take forms in which they are downloaded via a network from an external device.

The disclosure of Japanese Patent Application No. 2019-147196 filed on Aug. 9, 2019, is incorporated in its entirety by reference herein.

All documents, patent applications, and technical standards mentioned in this specification are incorporated by reference herein to the same extent as if each document, patent application, or technical standard were specifically and individually indicated to be incorporated by reference.

What is claimed is:

1. A vehicle driving system comprising:
an acquisition unit that acquires information relating to a state of a driver driving a first vehicle in a manual driving mode;
a switching control unit that switches the first vehicle from the manual driving mode to a remote driving mode in a case in which it is verified, by means of the information acquired by the acquisition unit, that it is difficult for the driver to drive; and
a notification unit that, in a case in which the first vehicle is switched to the remote driving mode by the switching control unit, notifies a second vehicle located within a predetermined range from the first vehicle that the first vehicle has become an urgent vehicle.

2. The vehicle driving system according to claim 1, further comprising a detection unit that detects, by means of the information acquired by the acquisition unit, that the driver is in a condition in which it is difficult to drive.

3. The vehicle driving system according to claim 1, wherein notification by the notification unit from the first vehicle to the second vehicle is performed via communication between the first vehicle and the second vehicle.

4. The vehicle driving system according to claim 1, wherein the notification unit notifies the second vehicle that the second vehicle needs to move out of a driving direction of the first vehicle.

5. The vehicle driving system according to claim 1, further comprising another switching control unit that switches the second vehicle to a remote driving mode in a case in which the second vehicle has been notified by the notification unit that the first vehicle has become an urgent vehicle.

6. The vehicle driving system according to claim 1, wherein the acquisition unit is installed in the first vehicle or is portably carried by the driver of the first vehicle.

7. The vehicle driving system according to claim 6, wherein the acquisition unit is a vitals sensor that detects vital signs of the driver of the first vehicle.

8. The vehicle driving system according to claim 7, further comprising a hospital information acquisition unit that acquires, in accordance with the vital signs detected by the vitals sensor, information associated with hospitals, within a predetermined range from the first vehicle, which are capable of admitting the driver.

9. The vehicle driving system according to claim 8, further comprising a destination setting unit that sets, in accordance with the information about the hospitals acquired by the hospital information acquisition unit, a destination of the first vehicle to an admitting hospital capable of admitting the driver.

10. The vehicle driving system according to claim 9, further comprising a vital signs transmission unit that transmits the vital signs of the driver to the admitting hospital.

11. The vehicle driving system according to claim 1, wherein the acquisition unit acquires, by means of a drive recorder provided in the second vehicle travelling in front of or behind the first vehicle, the information relating to the state of the driver of the first vehicle.

12. A vehicle driving system, comprising:
at least one processor,
the processor being configured to:
acquire information relating to a state of a driver driving a first vehicle in a manual driving mode;
switch the first vehicle from the manual driving mode to a remote driving mode in a case in which it is verified, by means of the information, that it is difficult for the driver to drive; and
notify a second vehicle located within a predetermined range from the first vehicle that the first vehicle has become an urgent vehicle.
